(19) United States
(12) Patent Application Publication
(10) Pub. No.: US 2025/0236123 A1
(43) Pub. Date: Jul. 24, 2025

(54) PRINTING CASSETTE INCLUDING CASE HAVING CONVEYING PATH FOR PRINTING TAPE AND REFLECTION WALL ARRANGED AT CONVEYING PATH

(71) Applicant: BROTHER KOGYO KABUSHIKI KAISHA, Nagoya (JP)

(72) Inventor: Yuya TAGAMI, Owariasahi (JP)

(21) Appl. No.: 19/174,340

(22) Filed: Apr. 9, 2025

Related U.S. Application Data
(63) Continuation of application No. PCT/JP2023/035649, filed on Sep. 29, 2023.

(30) Foreign Application Priority Data
Oct. 11, 2022 (JP) 2022-163371

(51) Int. Cl. B41J 15/04; B41J 3/407; B41J 11/00; B41J 32/00

(52) U.S. Cl. CPC B41J 15/044; B41J 3/4075; B41J 11/009; B41J 11/0095; B41J 15/042; B41J 32/00

(57) ABSTRACT

A printing cassette includes: a printing tape roll; and a case. The printing tape roll includes a printing tape. The case accommodates the printing tape roll. The printing tape has a final end portion in which at least one transparent part and at least one nontransparent part are arranged juxtaposed in a longitudinal direction of the printing tape. The case has: a conveying path along which the printing tape is conveyed toward a printing position; and a reflection wall arranged at the conveying path. The reflection wall is configured to reflect light that has entered the case and that has passed through the transparent part to allow the light to pass through the transparent part again and exit the case. A surface of the reflection wall includes a reflecting area configured to oppose the transparent part. The reflecting area has a color different from a color of the nontransparent part.

### REFERENCE TO RELATED APPLICATIONS

This is a by-pass continuation application of International Application No. PCT/JP2023/035649 filed on Sep. 29, 2023 which claims priority from Japanese Patent Application No. 2022-163371 filed on Oct. 11, 2022. The entire contents of the International Application and the priority application are incorporated herein by reference.

### BACKGROUND ART

In a printing device configured to perform printing on a printing tape, cassettes accommodating therein the printing tape are to be attached to and detached from a printing device body to replace and supply the printing tape. In such cassettes, there is conventionally known a configuration in which a transmission sensor including a light-emitting element and a light-receiving element is to be arranged within the cassette to detect a final end portion of the printing tape.

### SUMMARY

When detecting the final end portion of the printing tape with the transmission sensor as described above, a space into which the light-emitting element and the light-receiving element are to be inserted needs to be provided in the cassette, whereby downsizing of the cassette is limited.

In view of the foregoing, it is an object of the present disclosure to provide a printing cassette enabling a final end portion of a printing tape to be detected while downsizing of the printing cassette is realized.

In order to attain the above and other object, the present disclosure provides a printing cassette including: a printing tape roll; and a case. The printing tape roll includes a printing tape. The printing tape is wound. The case accommodates therein the printing tape roll. The printing tape has a final end portion in which at least one transparent part and at least one nontransparent part are arranged juxtaposed in a longitudinal direction of the printing tape. The case has: a conveying path along which the printing tape drawn out of the printing tape roll is to be conveyed toward a printing position; and a reflection wall. The reflection wall is arranged at the conveying path. The reflection wall is configured to reflect light that has entered an inside of the case from an outside of the case and that has passed through the transparent part to allow the light to pass through the transparent part again and exit the case. The reflection wall has a surface including a reflecting area configured to oppose the transparent part. The reflecting area has a color different from a color of the nontransparent part.

According to another aspect, the present disclosure also provides a printing device including: a cassette accommodation part into which a printing cassette is to be inserted; and a tape reading sensor. The tape reading sensor is configured to detect a final end of the printing tape. The printing cassette includes: a printing tape roll; and a case. The printing tape roll includes a printing tape. The printing tape is wound. The case accommodates therein the printing tape roll. The printing tape has a final end portion in which at least one transparent part and at least one nontransparent part are arranged juxtaposed in a longitudinal direction of the printing tape. The case has: a conveying path along which the printing tape drawn out of the printing tape roll is to be conveyed toward a printing position; and a reflection wall. The reflection wall is arranged at the conveying path. The reflection wall is configured to reflect light that has entered an inside of the case from an outside of the case and that has passed through the transparent part to allow the light to pass through the transparent part again and exit the case. The reflection wall has a surface including a reflecting area configured to oppose the transparent part. The reflecting area has a color different from a color of the nontransparent part.

With the above structures, a difference between the color of the reflection wall and the color of the nontransparent part of the printing tape enables the final end portion of the printing tape to be detected with the light entered from the outside of the printing cassette. Accordingly, there is no need to provide a space for arranging a sensor within the case of the printing cassette, thereby realizing downsizing of the printing cassette.

### BRIEF DESCRIPTION OF DRAWINGS

FIG. 1A is a schematic perspective view illustrating a printing device.

FIG. 1B is a schematic side view in which a cover of the printing device in FIG. 1A is detached.

FIG. 1C is a schematic rear view in which the cover of the printing device in FIG. 1A is detached.

FIGS. 2A and 2B are schematic partial cross-sectional view of a portion in the vicinity of a cassette accommodation part of a printing device body of the printing device in FIGS. 1A to 1C.

FIG. 3A is a schematic perspective view of a roller holder of the printing device body of the printing device in FIGS. 1A to 1C.

FIG. 3B is a schematic cross-sectional view taken along line IIIB-IIIB in FIG. 3A.

FIG. 4A is a schematic diagram illustrating a used state of the roller holder in FIGS. 3A and 3B.

FIG. 4B is a schematic plan view of the cassette accommodation part of the printing device body of the printing device in FIGS. 1A to 1C from which a printing cassette is detached.

FIG. 5 is a schematic perspective view of the printing cassette in the printing device in FIGS. 1A to 1C.

FIG. 6 is a schematic exploded perspective view of the printing cassette in FIG. 5.

FIG. 7 is a schematic diagram of a final end portion of a printing tape in the printing cassette in FIG. 5.

FIG. 8 is a schematic perspective view of a first cover part in the printing cassette in FIG. 5.

FIG. 9 is a schematic plan view of a first frame part and a second frame part in the printing cassette in FIG. 5.

FIG. 10 is a schematic perspective view of the first frame part and the second frame part in FIG. 9, and a second cover part.

FIG. 11 is a schematic rear view of the first frame part and the second frame part in the printing cassette in FIG. 5.

FIG. 12 is a schematic side view of the printing cassette in FIG. 5.

FIG. 13 is a schematic rear view of the printing cassette in FIG. 5.

FIG. 14A is a schematic cross-sectional view taken along line XIVA-XIVA in FIG. 13.

FIG. 14B is a schematic cross-sectional view taken along line XIVB-XIVB in FIG. 13.

FIG. 14C is a schematic cross-sectional view taken along line XIVC-XIVC in FIG. 13.

FIG. 14D is a schematic cross-sectional view taken along line XIVD-XIVD in FIG. 13.

FIGS. 15A, 15B, 15C, 15D, 15E, and 15F are schematic diagrams illustrating examples of an uneven shape.

FIG. 16 is a schematic plan view of the printing cassette in FIG. 5.

FIG. 17 is a schematic perspective view of the printing cassette in FIG. 5.

FIG. 18 is a schematic perspective view of a printing cassette.

### DESCRIPTION

### 1. First Embodiment

### 1-1. Configuration

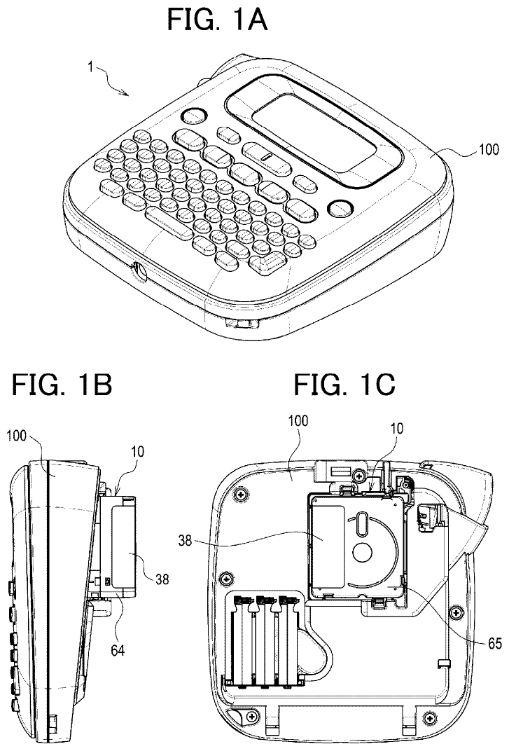

A printing device 1 illustrated in FIGS. 1A, 1B, and 1C includes a printing cassette 10, and a printing device body 100. The printing device 1 is a device configured to perform printing on a printing tape 11A.

In the present embodiment, a direction parallel to an axis of a printing tape roll 11 will be referred to as an up-down direction (an example of the first direction); among directions orthogonal to the up-down direction, a direction parallel to a direction in which the printing tape 11A is to be discharged through a discharge opening 42 will be referred to as a left-right direction (an example of the second direction); and a direction orthogonal to both the up-down direction and the left-right direction will be referred to as a front-rear direction.

Further, in the present embodiment, “overlapping in the up-down direction” signifies “overlapping when viewed in a direction parallel to the up-down direction,” and specifically signifies “overlapping in a projection view that is projected onto a virtual plane orthogonal to the up-down direction”. The same applies to the other directions.

### <Printing Device Body>

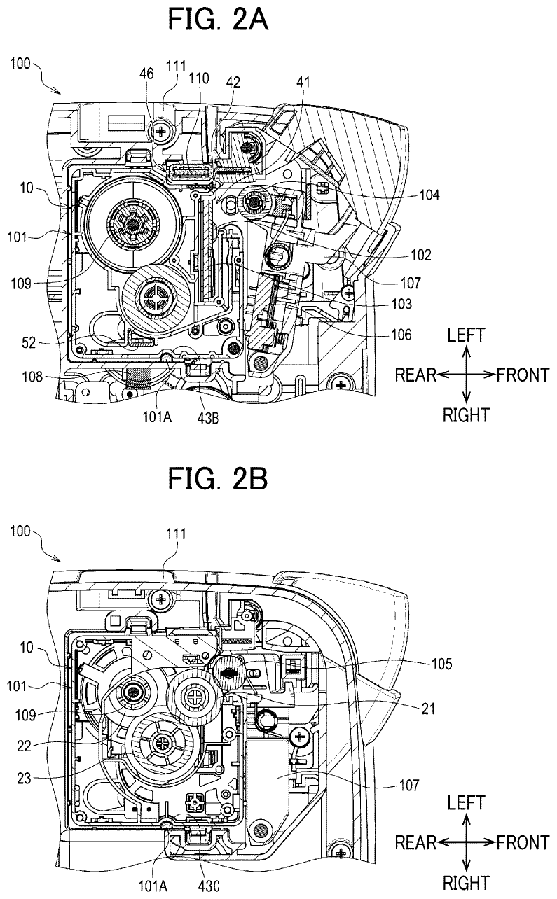

As illustrated in FIGS. 2A and 2B, the printing device body 100 includes a cassette accommodation part 101, a print head 102, a heat sink 103, a platen roller 104, a platen gear 105, a detection unit 106, a roller holder 107, a tape reading sensor 108, a drive shaft 109, a cutter 110, and a housing 111.

### (Cassette Accommodation Part)

The cassette accommodation part 101 is a recess into which the printing cassette 10 is to be inserted. The cassette accommodation part 101 has a function for positioning the printing cassette 10.

The cassette accommodation part 101 includes a protrusion 101A protruding leftward from a surface on the right side of the cassette accommodation part 101. The protrusion 101A extends in the up-down direction. The protrusion 101A is to be inserted into a second recess 43B and a third recess 43C of the printing cassette 10 in the up-down direction when the printing cassette 10 is inserted into the cassette accommodation part 101.

### (Print Head)

The print head 102 is arranged inside the cassette accommodation part 101. The print head 102 includes a plurality of heating elements whose heating is individually controlled.

### (Heat Sink)

The heat sink 103 holds the print head 102. The heat sink 103 is a metal plate arranged so that a thickness direction of the heat sink 103 is parallel to the front-rear direction. The heat sink 103 has a front surface to which the print head 102 is attached. The heat sink 103 has a function to dissipate heat from the print head 102.

### (Platen Roller)

The platen roller 104 is arranged inside the cassette accommodation part 101 near the print head 102 so as to oppose the print head 102.

The platen roller 104 is held by the roller holder 107 so as to be pivotally movable in directions toward and away from the print head 102. A rotational axis of the platen roller 104 is parallel to the up-down direction.

### (Platen Gear)

The platen gear 105 engages with an output gear 21 of the printing cassette 10. A rotational axis of the platen gear 105 coincides with the rotational axis of the platen roller 104. The platen gear 105 is coupled to the platen roller 104, and rotates and pivotally moves together with the platen roller 104. The platen gear 105 has angled teeth.

### (Detection Unit)

The detection unit 106 is configured to detect, from the printing cassette 10, cassette identification information assigned to the printing cassette 10. The detection unit 106 is configured to detect the cassette identification information from a detection target part 45 of the printing cassette 10 through a mechanical reading sensor.

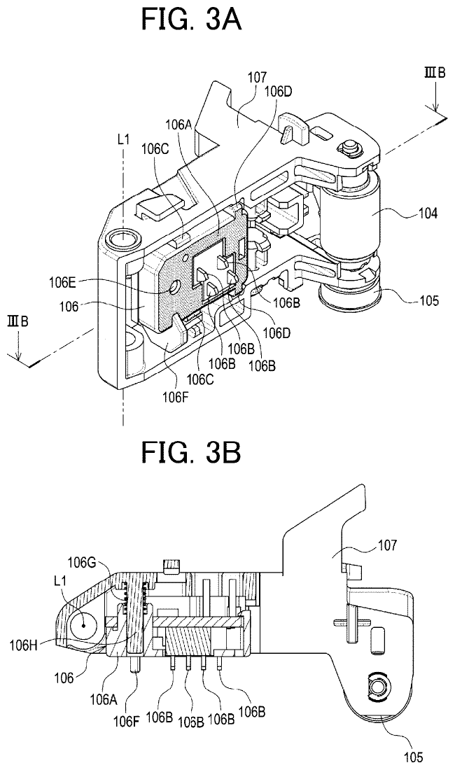

As illustrated in FIGS. 3A and 3B, the detection unit 106 includes a body 106A that includes electric circuits and the like, and a plurality of protrusions 106B that can be inserted into the printing cassette 10. Each of the protrusions 106B protrudes toward the printing cassette 10 from the body 106A. The protrusions 106B are attached to the body 106A so as to be movable in their protruding direction.

The body 106A includes a plurality of pawls 106C in engagement with the roller holder 107, and a plurality of ribs 106D restricting the body 106A from rotating relative to the roller holder 107. Also, the body 106A has a positioning hole 106E through which a shaft part 106H to which a spring 106G is attached is inserted.

The body 106A further includes an auxiliary rib 106F that protrudes from the body 106A toward the printing cassette 10. The auxiliary rib 106F protects the protrusions 106B by contacting a main case 31 of the printing cassette 10 prior to the protrusions 106B when the detection unit 106 is pressed against the printing cassette 10. The auxiliary rib 106F is arranged at a position closer to a pivot axis L1 of the roller holder 107 than the protrusions 106B are to the pivot axis L1 of the roller holder 107.

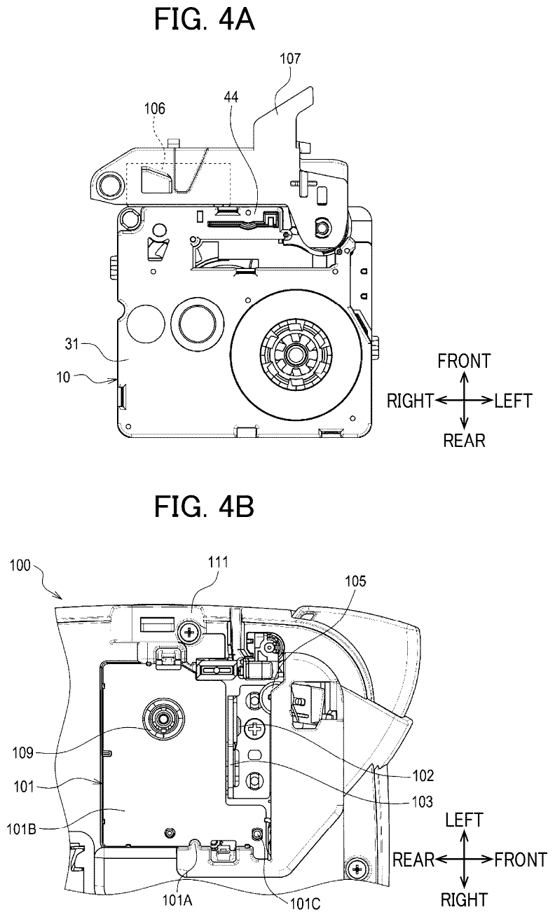

As illustrated in FIG. 4A, the detection unit 106 is pressed against an arm portion 44 of the printing cassette 10. In this state, a position of each of the plurality of protrusions 106B changes according to a shape of the detection target part 45 in the printing cassette 10. The protrusions 106B that contact the detection target part 45 are pushed toward an inside of the body 106A, while the protrusions 106B that do not contact the detection target part 45 are not pushed toward the inside of the body 106A.

The detection unit 106 reads cassette identification information corresponding to a pattern of the detection target part 45 in the printing cassette 10 based on the position of the plurality of protrusions 106B in the protruding direction (i.e., whether or not the plurality of protrusions 106B is pushed toward the inside of the body 106A).

### (Roller Holder)

The roller holder 107 holds the platen roller 104, the platen gear 105, and the detection unit 106. The roller holder 107 is attached to the housing 111 so as to be pivotally movable in the front-rear direction.

### (Tape Reading Sensor)

The tape reading sensor 108 illustrated in FIG. 2A is configured to detect a final end of the printing tape 11A (i.e., the printing tape roll 11) in the printing cassette 10.

The tape reading sensor 108 is arranged at a position opposing a reflection wall 52 of the printing cassette 10 in the left-right direction. The tape reading sensor 108 is configured to emit light toward the reflection wall 52 and to receive light that has passed through the printing tape 11A and has been reflected by the reflection wall 52. The tape reading sensor 108 is configured to determine that the printing tape 11A is used up on the basis of a pattern of received light.

### (Drive Shaft)

The drive shaft 109 illustrated in FIG. 2A is to be inserted into a take-up spool 16 and an input gear 22 in the printing cassette 10. The drive shaft 109 is configured to input a driving force into the printing cassette 10 for rotating the take-up spool 16 and the input gear 22.

The drive shaft 109 is arranged inside the cassette accommodation part 101. A rotational axis of the drive shaft 109 is parallel to the up-down direction. The drive shaft 109 is rotated about the rotational axis by a drive source (not illustrated) having a combination of a motor and gears, for example.

### (Cutter)

The cutter 110 is configured to cut the printing tape 11A discharged through the discharge opening 42 in the printing cassette 10 in a thickness direction of the printing tape 11A. The cutter 110 includes a blade that is movable in the front-rear direction inside the housing 111.

### <Printing Cassette>

The printing cassette 10 accommodates therein the printing tape 11A. The printing cassette 10 is attachable to and detachable from the printing device body 100. Replacement of the printing cassette 10 enables the printing tape 11A to be replenished and the type of the printing tape 11A (for example, the size, the color, and the material) to be changed.

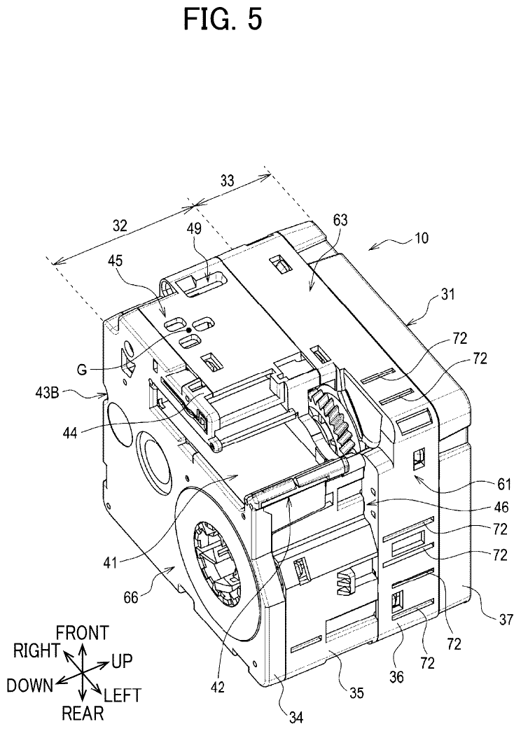

As illustrated in FIG. 5, the printing cassette 10 includes a main case 31 (an example of the case) that accommodates therein at least a part of the printing tape 11A and at least a part of an ink ribbon 14A.

The main case 31 includes a first case 32, and a second case 33. Each of the first case 32 and the second case 33 has a rectangular parallelepiped shape having sides that are parallel to the up-down direction, sides that are parallel to the front-rear direction, and sides that are parallel to the left-right direction. In other words, the main case 31 has a rectangular outer shape when viewed in the up-down direction.

The first case 32 is connected to the second case 33 so as to protrude downward from a lower surface of the second case 33. The main case 31 is to be inserted into the cassette accommodation part 101 with the first case 32 opposing a bottom surface 101B in the cassette accommodation part 101 (see FIG. 4B).

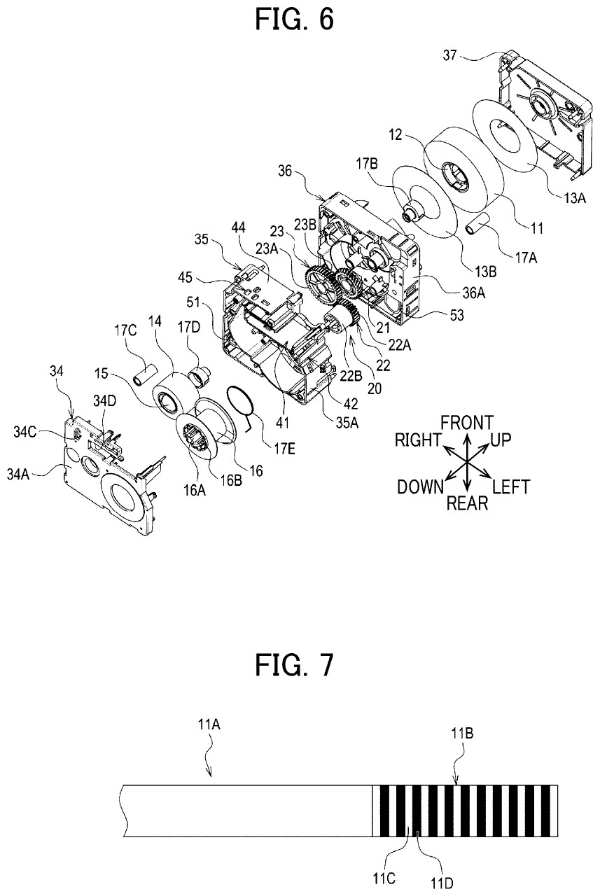

As illustrated in FIG. 6, the printing cassette 10 includes the printing tape roll 11, a first supply spool 12, an ink ribbon roll 14, a second supply spool 15, the take-up spool 16, and a drive transmission mechanism 20.

### (Printing Tape Roll)

The printing tape roll 11 includes a strip of the printing tape 11A. The printing tape 11A is wound over the first supply spool 12 about an axis of the printing tape roll 11. The printing tape 11A is to be used for printing. Printing is performed on a surface of the printing tape 11A using the print head 102 of the printing device body 100 and the ink ribbon 14A. The axis of the printing tape roll 11 is parallel to the up-down direction.

Two spacer films 13A and 13B are arranged on respective outer sides of the printing tape roll 11 in the up-down direction so as to sandwich the printing tape roll 11. The spacer films 13A and 13B are arranged between the printing tape roll 11 and a second cover part 37 and between the printing tape roll 11 and a second frame part 36, respectively. The printing tape 11A drawn off the printing tape roll 11 is guided by a first roller 17A and a second roller 17C.

Masking tape can be used as the printing tape 11A, for example. As illustrated in FIG. 7, the printing tape 11A has a final end portion 11B. At least one transparent part 11C and at least one nontransparent part 11D are arranged juxtaposed in a longitudinal direction of the printing tape 11A in the final end portion 11B.

Specifically, a plurality of transparent parts 11C and a plurality of nontransparent parts 11D are arranged alternately in the longitudinal direction of the printing tape 11A in the final end portion 11B. The transparent parts 11C are colorless and transparent, for example. The nontransparent parts 11D are colored black, for example. The plurality of transparent parts 11C and the plurality of nontransparent parts 11D have widths the same as one another.

The final end portion 11B is fixed to the first supply spool 12. A length of the final end portion 11B is greater than a distance from the first supply spool 12 to the reflection wall 52 at a conveying path for the printing tape 11A.

### (First Supply Spool)

The first supply spool 12 illustrated in FIG. 6 is rotatable about a rotational axis parallel to the up-down direction. The first supply spool 12 supplies the printing tape 11A to a head opening 41 by rotating as the platen roller 104 of the printing device body 100 conveys the printing tape 11A.

The rotational axis of the first supply spool 12 coincides with the axis of the printing tape roll 11. A rotational resistance is applied to the first supply spool 12 by a clutch spring held by a first clutch spring holder 17B.

### (Ink Ribbon Roll)

The ink ribbon roll 14 includes a strip of the ink ribbon 14A. The ink ribbon 14A is wound over the second supply spool 15 about an axis of the ink ribbon roll 14. The ink ribbon 14A is to be used for perform printing on the printing tape 11A.

The ink ribbon 14A is overlaid on the printing tape 11A in the head opening 41 and is to be used for printing by the print head 102. After used for printing, the ink ribbon 14A is taken up by the take-up spool 16.

The ink ribbon roll 14 is arranged at a different position from the printing tape roll 11 in the up-down direction (specifically, is positioned downward of the printing tape roll 11). Further, the ink ribbon roll 14 is arranged at the same position as the head opening 41 in the up-down direction. In other words, the ink ribbon roll 14 is positioned at a different position from the printing tape roll 11 in the up-down direction.

### (Second Supply Spool)

The second supply spool 15 is rotatable about a rotational axis. The rotational axis of the second supply spool 15 is parallel to the up-down direction.

The second supply spool 15 supplies the ink ribbon 14A to the print head 102 by rotating as the take-up spool 16 takes up the ink ribbon 14A. A rotational resistance is applied to the second supply spool 15 by a clutch spring held by a second clutch spring holder 17D.

The first clutch spring holder 17B and the second clutch spring holder 17D have the same shape but are colored with different colors from each other. This configuration can restrain assembly errors while reducing cost through use of common parts.

### (Take-up Spool)

The take-up spool 16 is rotatable about a rotational axis. The rotational axis of the take-up spool 16 is parallel to the rotational axis of the second supply spool 15.

The take-up spool 16 has a hollow cylindrical shape and has a hollow area defined by an inner circumferential surface 16A. Splines 16B are provided at the inner circumferential surface 16A of the take-up spool 16. The drive shaft 109 of the printing device body 100 is to be coupled to the splines 16B. The take-up spool 16 is rotated by the drive shaft 109 to take up the ink ribbon 14A.

A rotational resistance is applied to the take-up spool 16 by a torsion spring 17E. The torsion spring 17E is arranged between the take-up spool 16 and a first frame part 35.

### (Drive Transmission Mechanism)

The drive transmission mechanism 20 transmits a driving force received from the drive shaft 109 to the platen roller 104 when the printing cassette 10 is attached to the printing device body 100. The drive transmission mechanism 20 includes the output gear 21, the input gear 22, and an idle gear 23.

The printing tape roll 11, the drive transmission mechanism 20, and the take-up spool 16 are arranged in the up-down direction in order of the printing tape roll 11, the drive transmission mechanism 20, and the take-up spool 16.

### (Output Gear)

The output gear 21 is an external gear for externally outputting a driving force used for conveying the printing tape 11A. Specifically, the output gear 21 transmits a driving force to the platen gear 105 of the printing device body 100. The output gear 21 has angled teeth that meshingly engage with the angled teeth of the platen gear 105.

A rotational axis of the output gear 21 is parallel to the rotational axis of the second supply spool 15. A part of the output gear 21 is exposed to a space that communicates with the head opening 41. The output gear 21 engages with the platen gear 105 in the space communicating with the head opening 41 in a state where the printing cassette 10 is attached to the printing device body 100 (i.e., in a state where the main case 31 is accommodated in the cassette accommodation part 101).

The output gear 21 is arranged closer to the printing tape roll 11 than the detection target part 45 is to the printing tape roll 11 in the up-down direction (i.e., is arranged further upward relative to the detection target part 45). Further, the output gear 21 is arranged between the printing tape roll 11 and the ink ribbon roll 14 in the up-down direction. Still further, the output gear 21 is arranged between a first sloped guide 51 and a second sloped guide 53 in the up-down direction.

### (Input Gear)

The input gear 22 indirectly engages with the output gear 21 via the idle gear 23 and transmits a driving force to the output gear 21.

The input gear 22 includes an external gear 22A, and a spool 22B which is a cylindrical internal gear fixed to one side surface of the external gear 22A and including splines on an inner circumferential surface thereof. The external gear 22A rotates together with the spool 22B due to a driving force inputted into the spool 22B. A rotational axis of the input gear 22 (i.e., rotational axes of the external gear 22A and the spool 22B) is on the same line as the rotational axis of the take-up spool 16.

The rotational axis of the input gear 22 overlaps the hollow area in the take-up spool 16 in the up-down direction. Accordingly, the drive shaft 109 is simultaneously inserted in the take-up spool 16 and the input gear 22 in a state where the printing cassette 10 is attached to the printing device body 100. As a result, the input gear 22, although not directly coupled to the take-up spool 16, is rotated together with the take-up spool 16 by the drive shaft 109.

### (Idle Gear)

The idle gear 23 is drivingly coupled to (i.e., engages with) the input gear 22 and the output gear 21 for transmitting the driving force inputted into the input gear 22 to the output gear 21.

The idle gear 23 is a stepped gear including an upstream gear 23A engaging with the input gear 22, and a downstream gear 23B engaging with the output gear 21. The upstream gear 23A and the downstream gear 23B are arranged on the same line as each other. The downstream gear 23B has a diameter smaller than that of the upstream gear 23A. Further, the downstream gear 23B is arranged at a position closer to the printing tape roll 11 than the upstream gear 23A is to the printing tape roll 11 in the up-down direction (i.e., is positioned upward of the upstream gear 23A).

The idle gear 23 transmits the driving force inputted into the input gear 22 to the output gear 21 after reducing a rotational speed of the driving force. That is, the drive transmission mechanism 20 includes a reduction mechanism whose reduction ratio is a transmission ratio obtained by dividing a rotational speed of the input gear 22 by a rotational speed of the output gear 21.

### (Case)

The main case 31 includes a first cover part 34, the first frame part 35, the second frame part 36, and the second cover part 37.

The first cover part 34 constitutes a lower end portion of the printing cassette 10. The first frame part 35 is arranged upward of the first cover part 34, and is coupled to the first cover part 34 in the up-down direction. The second frame part 36 is arranged upward of the first frame part 35, and is coupled to the first frame part 35 in the up-down direction. The second cover part 37 constitutes an upper end portion of the printing cassette 10. The second cover part 37 is coupled to the second frame part 36 in the up-down direction.

The first cover part 34, the first frame part 35, and a part of the second frame part 36 constitute the first case 32, which accommodates therein the ink ribbon roll 14, the second supply spool 15, the take-up spool 16, and the drive transmission mechanism 20. The first case 32 is arranged at a different position from the printing tape roll 11 in the up-down direction (specifically, is arranged downward of the printing tape roll 11).

The ink ribbon roll 14, the second supply spool 15, and the take-up spool 16 are arranged in a space enclosed by the first cover part 34 and the first frame part 35. The drive transmission mechanism 20 is arranged in a space enclosed by the first frame part 35 and the second frame part 36.

The second cover part 37 and the second frame part 36 constitute the second case 33, which accommodates therein the printing tape roll 11. In other words, the printing tape roll 11 is arranged in a space enclosed by the second cover part 37 and the second frame part 36.

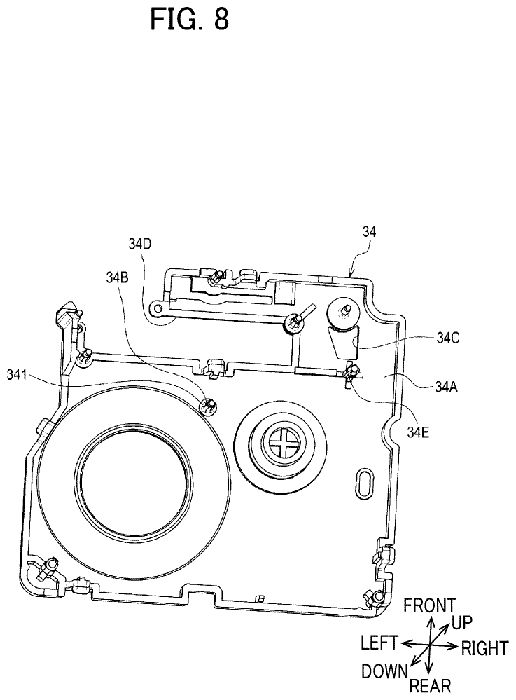

As illustrated in FIG. 8, the first cover part 34 has a first cover body 34A, a first insertion pin 34B, a first confirmation window 34C, a notch 34D, and a second insertion pin 34E. The first cover body 34A constitutes a lower outer surface 66 of the main case 31.

The first insertion pin 34B and the second insertion pin 34E protrude upward from an inner surface of the first cover body 34A. The first insertion pin 34B and the second insertion pin 34E are respectively inserted in holes in the first frame part 35.

The first insertion pin 34B includes a base 341 having a diameter greater than that of a body of the first insertion pin 34B. The base 341 protrudes from the inner surface of the first cover body 34A. The body of the first insertion pin 34B protrudes from an upper surface of the base 341.

The first confirmation window 34C is arranged rightward of the notch 34D, which defines a part of the head openings 41. The presence of the second roller 17C can be confirmed through the first confirmation window 34C. The notch 34D is provided at a position overlapping the head opening 41 in the up-down direction.

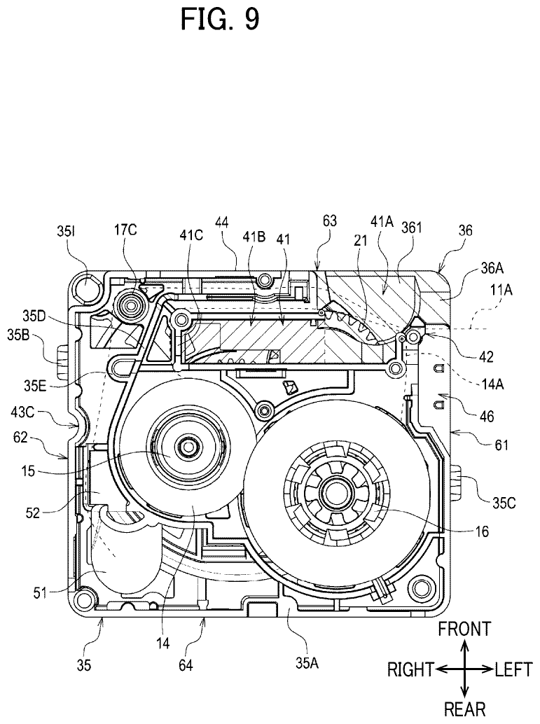

As illustrated in FIG. 9, the first frame part 35 includes a first frame body 35A, a first engaging part 35B, a second engaging part 35C, a partition wall 35D, a positioning part 35E, the head opening 41 (an example of the opening), the discharge opening 42, the arm portion 44, the first sloped guide 51 (an example of the guide), and the reflection wall 52. The first frame body 35A constitutes outer side surfaces of the main case 31 that are parallel to the up-down direction.

The first engaging part 35B protrudes rightward from a region of a right outer surface 62 of the main case 31 that is further frontward relative to the third recess 43C. The second engaging part 35C protrudes leftward from a region of a left outer surface 61 of the main case 31 that is further rearward relative to an accommodation part 46. Each of the first engaging part 35B and the second engaging part 35C is a pawl that is engageable with the cassette accommodation part 101 into which the main case 31 is to be inserted.

The partition wall 35D partitions the conveying path for the printing tape 11A from a conveying path for the ink ribbon 14A. The partition wall 35D extends from the first sloped guide 51 and the reflection wall 52 to a left end portion of the arm portion 44 (i.e., an exit of the printing tape 11A and the ink ribbon 14A).

The positioning part 35E is a tubular part in which the second insertion pin 34E of the first cover part 34 is inserted in the up-down direction. The positioning part 35E has a function for positioning the first cover part 34 relative to the first frame part 35 and a function for stopping rotation of the first cover part 34. Specifically, the positioning part 35E protrudes rightward from the partition wall 35D. The printing tape 11A is conveyed while in contact with an outer circumferential surface of the positioning part 35E.

The printing tape 11A is exposed outside of the main case 31 in the head opening 41. The head opening 41 is a part formed by cutting out a part of the first frame body 35A. The head opening 41 extends in the up-down direction.

The head opening 41 is a space in which the print head 102 and the heat sink 103 are arranged in a state where the printing cassette 10 is attached to the printing device body 100. In other words, the head opening 41 is constituted by a printing space 41A in which printing is to be performed, and a head insertion space 41B in communication with the printing space 41A in the left-right direction.

In the head opening 41, printing is performed on the printing tape 11A by the print head 102. That is, the head opening 41 is provided at a printing position in the main case 31. The head opening 41 is open on a lower portion of the printing cassette 10 to allow the print head 102 to be inserted thereinto. The head opening 41 (i.e., the printing position) is formed at a different position from the printing tape roll 11 in the up-down direction.

The printing tape 11A and the ink ribbon 14A bridge over the printing space 41A of the head opening 41 in the left-right direction. In the head opening 41, the printing tape 11A is exposed outside the main case 31 and is overlaid on the ink ribbon 14A. The printing tape 11A on which printing has been performed is discharged out of the printing device 1 through the discharge opening 42. A discharging direction in which the printing tape 11A is discharged at the discharge opening 42 is a leftward direction.

The printing tape 11A and the ink ribbon 14A is conveyed in the left-right direction in the arm portion 44 on the upstream side of the printing space 41A in the discharging direction of the printing tape 11A and the ink ribbon 14A.

The arm portion 44 constitutes a tunnel portion that surrounds the printing tape 11A and the ink ribbon 14A in a width direction and a thickness direction. The arm portion 44 is positioned frontward of the head insertion space 41B. A right end portion of the arm portion 44 is supported in the front-rear direction by a right side wall 41C of the head insertion space 41B. On the other hand, a left end portion of the arm portion 44 is not supported in the front-rear direction.

The first sloped guide 51 is constituted by a part of a tube or an elliptic tube. The first sloped guide 51 has a curved surface (i.e., an outer circumferential surface) that contacts the printing tape 11A. An inner space of the tube constituting the first sloped guide 51 extends to an upper surface of the first frame part 35. In other words, a hole is formed in the upper surface of the first frame part 35 at a position overlapping the first sloped guide 51.

The first sloped guide 51 is arranged, inside the first frame body 35A, at the conveying path for the printing tape 11A in the first case 32. The first sloped guide 51 is arranged at a position overlapping the head opening 41 (i.e., the printing position) in a direction orthogonal to the up-down direction (i.e., a radial direction of the printing tape roll 11). In other words, the first sloped guide 51 is arranged inside the main case 31 at a position overlapping the printing tape roll 11 in the up-down direction.

The printing tape 11A drawn off the printing tape roll 11 inside the second case 33 enters the first case 32 while running along the outer circumferential surface of the first sloped guide 51. The printing tape 11A is subsequently conveyed toward the head opening 41 and the discharge opening 42 while in contact with the second roller 17C.

In other words, the first sloped guide 51 alters a conveying direction of the printing tape 11A from a direction crossing both the up-down direction and the front-rear direction to the front-rear direction (i.e., a direction orthogonal to the up-down direction). Thus, the first sloped guide 51 alters a component of the conveying direction for the printing tape 11A that is parallel to the up-down direction and a component of the conveying direction for the printing tape 11A that is parallel to the front-rear direction.

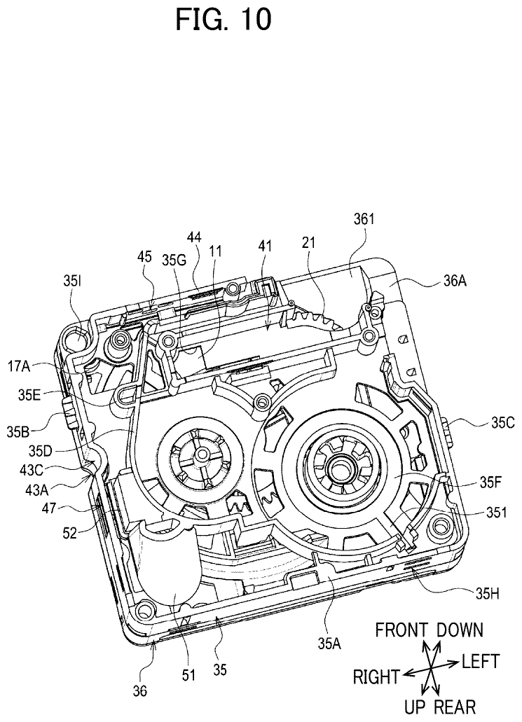

The reflection wall 52 illustrated in FIG. 10 is arranged at a region of the conveying path for the printing tape 11A that the printing tape 11A is conveyed parallel to the front-rear direction and is not conveyed in the up-down direction (i.e., a region in which the longitudinal direction of the printing tape 11A is orthogonal to the up-down direction). The reflection wall 52 enables the tape reading sensor 108 of the printing device body 100 to detect the final end portion 11B of the printing tape 11A.

Specifically, the reflection wall 52 is configured to reflect light that has entered an inside of the main case 31 from an outside of the main case 31 and that has passed through the transparent parts 11C of the printing tape 11A to allow the reflected light to pass through the transparent parts 11C again and exit the main case 31.

A surface of the reflection wall 52 includes a reflecting area configured to oppose the transparent parts 11C of the printing tape 11A. The reflecting area has a color that is different from a color of the nontransparent parts 11D in the printing tape 11A. Specifically, the color of the reflecting area is a color other than black, and preferably, white. Moreover, in an inner wall of the first frame part 35, at least a region upstream or downstream relative to the reflection wall 52 in the conveying path for the printing tape 11A is colored black.

Among lights emitted by the tape reading sensor 108, the light that has passed through the transparent parts 11C and has been reflected without being absorbed by the nontransparent parts 11D or the regions other than the reflection wall 52 at the conveying path reaches the tape reading sensor 108. The tape reading sensor 108 detects the final end portion 11B of the printing tape 11A (i.e., a layout pattern of the transparent parts 11C and the nontransparent parts 11D) based on a pattern of received light. Based on the detection of the final end portion 11B by the tape reading sensor 108, the printing device body 100 notifies a user that there is little printing tape 11A remaining.

The reflection wall 52 overlaps the head opening 41 (i.e., the printing position) in a direction orthogonal to the up-down direction (i.e., the radial direction of the printing tape roll 11). The reflection wall 52 is arranged adjacent to the first sloped guide 51 on the downstream side of the first sloped guide 51 in the conveying direction of the printing tape 11A.

The first sloped guide 51 is integrated with the first frame body 35A. The reflection wall 52 is configured as an assembly component that is attachable to and detachable from the first frame body 35A and the first sloped guide 51. The reflection wall 52 is inserted in the first frame body 35A in the up-down direction.

The reflection wall 52 may also be configured as an assembly component integrated with the first sloped guide 51. In this case, the reflection wall 52 is attachable to and detachable from the first frame body 35A together with the first sloped guide 51. Together with the reflection wall 52, the first sloped guide 51 is supported by the first frame body 35A (an example of the case body).

As illustrated in FIG. 9, the second roller 17C is arranged at the conveying path for the printing tape 11A between the reflection wall 52 and the head opening 41. The printing tape 11A runs along the second roller 17C on the downstream side of the first sloped guide 51 and the reflection wall 52. The second roller 17C rotates about an axis thereof in accordance with conveyance of the printing tape 11A.

As illustrated in FIG. 10, the first frame part 35 has a spring placement groove 35F, and includes a second confirmation window 35G, a third confirmation window 35H, and a contact part 35I.

The spring placement groove 35F is a recess in which the torsion spring 17E is arranged. The spring placement groove 35F has a slit 351 in which one end portion of the torsion spring 17E is arranged. The slit 351 extends rearward and leftward from the rotational axis of the take-up spool 16. This configuration facilitates assembly of the torsion spring 17E.

In a case where the one end portion of the torsion spring 17E is not properly arranged in the slit 351, the torsion spring 17E interferes with other components and the first frame part 35 cannot be closed by the first cover part 34. As a result, assembly issues with the torsion spring 17E can be detected.

The second confirmation window 35G is formed at an upper surface of the head opening 41. The second confirmation window 35G is formed at a position overlapping the printing tape roll 11 in the up-down direction. The presence of the spacer film 13B can be confirmed through the second confirmation window 35G.

The third confirmation window 35H is formed at a rear surface of the first frame body 35A. The third confirmation window 35H is formed at a position overlapping the torsion spring 17E in the front-rear direction. The presence of the torsion spring 17E can be confirmed through the third confirmation window 35H.

As illustrated in FIG. 9, the contact part 351 is provided at a corner of the first frame part 35 that contains the right outer surface 62 of the main case 31 when viewed in the up-down direction (specifically, at a right-front corner). In a state where the main case 31 is inserted in the cassette accommodation part 101, the contact part 351 is in contact with a shaft part 101C, which extends upward from the bottom surface 101B of the cassette accommodation part 101 (see FIG. 4B), in the up-down direction. The contact part 35I has a function for positioning the printing cassette 10 relative to the cassette accommodation part 101 and a function for stopping rotation of the printing cassette 10.

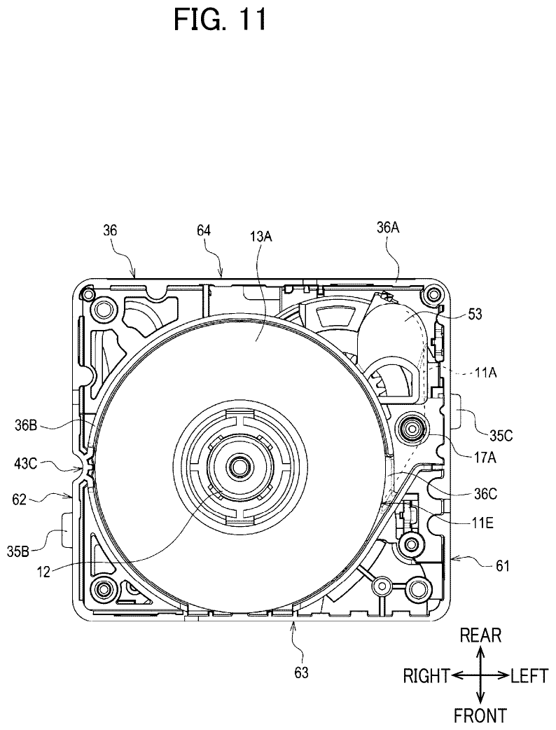

The second frame part 36 illustrated in FIG. 11 includes a second frame body 36A, a roll frame wall 36B, a tape exit 36C, and the second sloped guide 53. The second frame body 36A constitutes outer side surfaces of the main case 31 that are parallel to the up-down direction.

The roll frame wall 36B surrounds the printing tape roll 11 at a region further inward relative to the right outer surface 62 of the main case 31. The tape exit 36C is a portion allowing an inside of the roll frame wall 36B and an outside of the roll frame wall 36B to communicate with each other. The printing tape 11A is discharged from the roll frame wall 36B through the tape exit 36C. A step along the up-down direction is provided at the tape exit 36C to extend in the conveying direction of the printing tape 11A, and a corner of the step is chamfered.

The second sloped guide 53 is constituted by a part of a tube or an elliptic tube. The second sloped guide 53 has a curved surface (i.e., an outer circumferential surface) that contacts the printing tape 11A. An inner space of the tube constituting the second sloped guide 53 reaches a lower surface of the second frame part 36. That is, a hole is formed in the lower surface of the second frame part 36 at a position overlapping the second sloped guide 53.

The second sloped guide 53 is arranged, inside the second frame body 36, at the conveying path for the printing tape 11A in the second case 33. The second sloped guide 53 overlaps the printing tape roll 11 in a direction orthogonal to the up-down direction (i.e., the radial direction of the printing tape roll 11). Further, the second sloped guide 53 is arranged at a different position from the first sloped guide 51 in the up-down direction (i.e., at a position upward of the first sloped guide 51).

The second sloped guide 53 alters the conveying direction of the printing tape 11A from the front-rear direction to a direction crossing both the up-down direction and the front-rear direction. In other words, the second sloped guide 53 alters a component of the conveying direction for the printing tape 11A that is parallel to the up-down direction and a component of the conveying direction for the printing tape 11A that is parallel to the front-rear direction.

The second sloped guide 53 is an assembly component that is attachable to and detachable from the second frame body 36A. The second frame body 36A supports the second sloped guide 53.

The first roller 17A is arranged at the conveying path for the printing tape 11A between the printing tape roll 11 and the second sloped guide 53 (i.e., in the vicinity of a point in which the printing tape 11A is drawn off the printing tape roll 11). The printing tape 11A runs along the first roller 17A on the upstream side of the second sloped guide 53. The first roller 17A rotates about an axis thereof in accordance with the conveyance of the printing tape 11A.

As illustrated in FIG. 10, the second frame body 36A includes a platen gear opposing wall 361. The platen gear opposing wall 361 is arranged further upward relative to the output gear 21. The platen gear opposing wall 361 opposes the platen gear 105 in the up-down direction in a state where the main case 31 is inserted in the cassette accommodation part 101.

A lower surface of the platen gear opposing wall 361 is offset upward (i.e., recessed) relative to other lower surfaces of the second frame body 36A. This configuration restrains the platen gear 105 from interfering with the second frame body 36A when the platen gear 105 moves upward due to a thrust load.

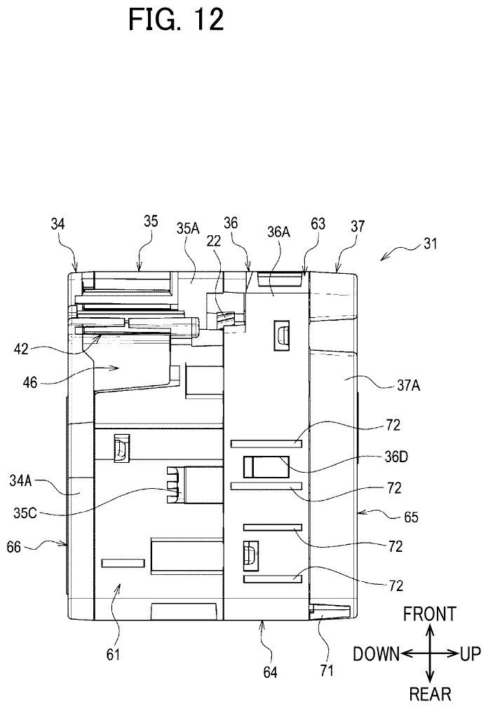

As illustrated in FIG. 12, the second frame part 36 has a fourth confirmation window 36D. The fourth confirmation window 36D is formed at a portion of the second frame body 36A that constitute the left outer surface 61. The fourth confirmation window 36D is formed at a position overlapping the first roller 17A in the left-right direction. The presence of the first roller 17A can be confirmed through the fourth confirmation window 36D.

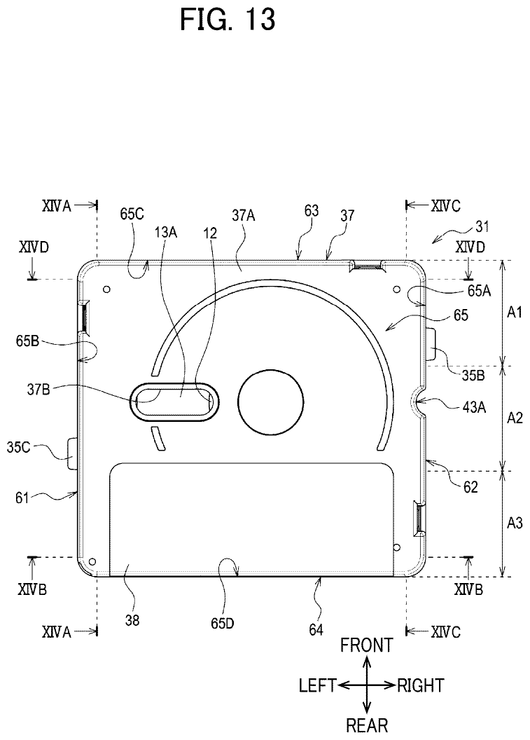

As illustrated in FIG. 13, the second cover part 37 includes a second cover body 37A, and has a remaining quantity confirmation window 37B. The second cover body 37A constitutes an upper outer surface 65 of the main case 31. The remaining quantity confirmation window 37B is formed at a position overlapping the printing tape roll 11 in the up-down direction. A remaining quantity of the printing tape roll 11 can be confirmed through the remaining quantity confirmation window 37B.

The presence and the color of the first supply spool 12 can also be confirmed through the remaining quantity confirmation window 37B. After the printing cassette 10 is assembled, the manufacturer and the manufacturing location of the printing tape roll 11 can be traced by checking the color of the first supply spool 12.

A label 38 on which cassette information and the like is printed is affixed to a rear portion of the second cover part 37. As illustrated in FIGS. 1B and 1C, the label 38 is affixed so as to be spanned over the upper outer surface 65 and a rear outer surface 64 of the main case 31.

### <Conveying Path for Printing Tape>

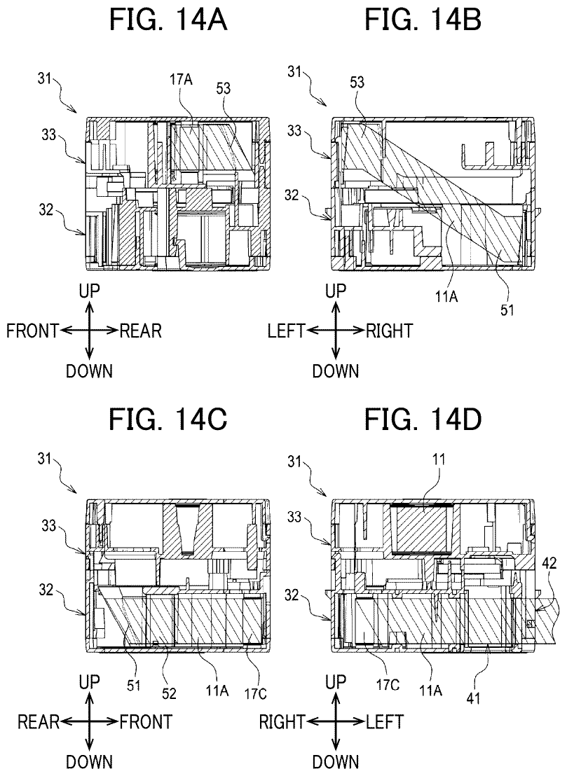

As illustrated in FIGS. 14A, 14B, 14C, and 14D, the first sloped guide 51 and the second sloped guide 53 constitute the conveying path along which the printing tape 11A is conveyed from the second case 33 to the first case 32.

That is, the main case 31 has the conveying path for conveying the printing tape 11A from the printing tape roll 11 toward the head opening 41, which is at a different position from the printing tape roll 11 in the up-down direction.

Specifically, the printing tape 11A drawn out of the printing tape roll 11 is conveyed downward and rearward by contacting the second sloped guide 53 from radially outside the printing tape roll 11, as illustrated in FIG. 14A.

After passing the second sloped guide 53, the printing tape 11A is conveyed downward and leftward toward the first sloped guide 51, as illustrated in FIG. 14B. The printing tape 11A is spanned over the second sloped guide 53 and the first sloped guide 51 in order of the second sloped guide 53 and the first sloped guide 51. Twist added to the printing tape 11A by the second sloped guide 53 is cancelled by the first sloped guide 51.

The printing tape 11A does not contact the main case 31 between the second sloped guide 53 and the first sloped guide 51. In other words, the main case 31 has no other guide parts, at the conveying path for the printing tape 11A, arranged between the second sloped guide 53 and the first sloped guide 51. Further, inner walls of the main case 31 between the second sloped guide 53 and the first sloped guide 51 (i.e., walls opposing outer walls that constitute outer surfaces of the main case 31) are positioned further frontward relative to the printing tape 11A.

After reaching the first sloped guide 51, the printing tape 11A is conveyed frontward by contacting the first sloped guide 51 from radially outside of the ink ribbon roll 14, as illustrated in FIG. 14C. After passing the first sloped guide 51, the printing tape 11A moves past a reading window 47 while in contact with the reflection wall 52.

After passing the first sloped guide 51, the printing tape 11A is guided by the second roller 17C, and is conveyed rightward, as illustrated in FIG. 14D. Thereafter, the printing tape 11A passes through the head opening 41 and is discharged through the discharge opening 42.

### <Low-Friction Contact Surfaces>

The reflection wall 52 has a first low-friction contact surface that contacts a printing surface of the printing tape 11A (i.e., a surface that is overlaid on the ink ribbon 14A in the head opening 41) at the conveying path for the printing tape 11A.

The first sloped guide 51 has a second low-friction contact surface that contacts the printing surface of the printing tape 11A at the conveying path for the printing tape 11A. The second low-friction contact surface is provided on the curved surface of the first sloped guide 51.

The second sloped guide 53 has a third low-friction contact surface that contacts the printing surface of the printing tape 11A at the conveying path for the printing tape 11A. The third low-friction contact surface is provided on the curved surface of the second sloped guide 53.

A roughness of the first low-friction contact surface is greater than a roughness of at least a part of surfaces that contact the printing tape 11A in regions of the conveying path that are on the upstream side and the downstream side of the first low-friction contact surface. A roughness of the second low-friction contact surface is greater than a roughness of at least a part of surfaces that contact the printing tape 11A in regions of the conveying path that are on the upstream side and the downstream side of the second low-friction contact surface. A roughness of the third low-friction contact surface is greater than a roughness of at least a part of surfaces that contact the printing tape 11A in regions of the conveying path that are on the upstream side and the downstream side of the third low-friction contact surface.

In other words, the conveying path for the printing tape 11A has regions on the upstream side or the downstream side of each of the first low-friction contact surface, the second low-friction contact surface, and the third low-friction contact surface with less roughness than the roughness of the respective first low-friction contact surface, second low-friction contact surface, and third low-friction contact surface.

Specifically, the arithmetic mean roughness Ra of the first low-friction contact surface, the second low-friction contact surface, and the third low-friction contact surface is greater than or equal to 3 μm and is smaller than or equal to 20 μm. By setting the arithmetic mean roughness Ra in such a range, the frictional resistance can be reduced while maintaining the guiding function.

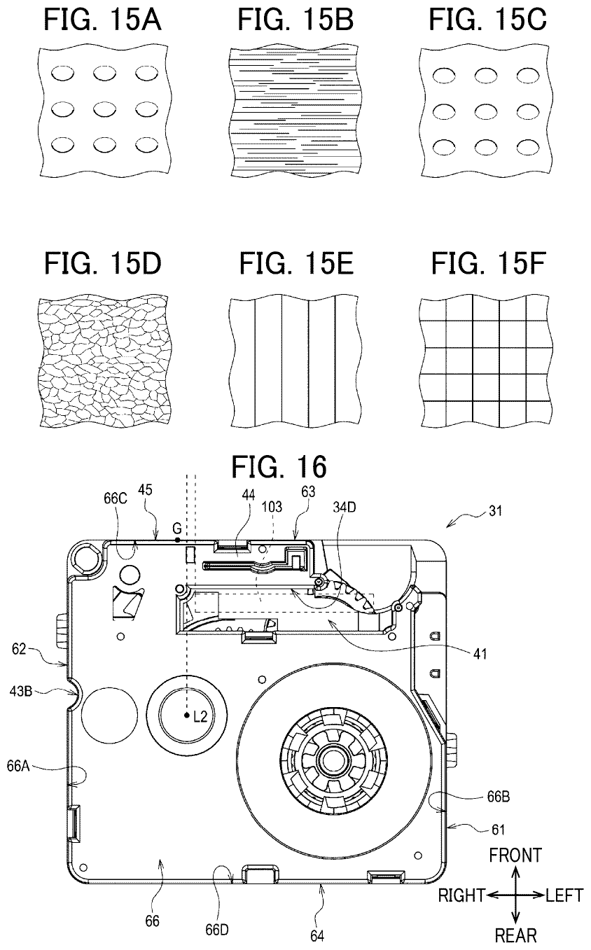

Each of the first low-friction contact surface, the second low-friction contact surface, and the third low-friction contact surface has an uneven shape that contacts the printing tape 11A. A plurality of dimples illustrated in FIG. 15A, a hairline pattern illustrated in FIG. 15B, a plurality of dots illustrated in FIG. 15C, a grain pattern illustrated in FIG. 15D, and a plurality of grooves illustrated in FIGS. 15E and 15F may be employed as the uneven shape.

Instead of having an uneven shape or in combination with an uneven shape, each of the first low-friction contact surface, the second low-friction contact surface, and the third low- friction contact surface may be composed of resin having a lower coefficient of friction than resin composing parts of the main case 31 other than the low-friction contact surfaces (i.e., the first frame body 35A and the second frame body 36A).

Specifically, the material of the first frame body 35A and the second frame body 36A can be acrylonitrile butadiene styrene (ABS) resin, while the material of the reflection wall 52, the first sloped guide 51, and the second sloped guide 53 can be polyoxymethylene (POM) resin or polybutylene terephthalate (PBT) resin.

Each of the first low-friction contact surface, the second low-friction contact surface, and the third low-friction contact surface may be configured of a coating material. The coating material is a surface layer of film that is affixed to inner surfaces of the conveying path (i.e., surfaces of the base material forming the reflection wall 52, the first sloped guide 51, and the second sloped guide 53). The film has an adhesive layer, and the surface layer composed of the coating material.

Note that a low-friction contact surface may not be provided on one of the first sloped guide 51 and the second sloped guide 53. In this case, the sloped guide not having a low-friction contact surface is integrated with the first frame body 35A or the second frame body 36A, and is preferably composed of acrylonitrile butadiene styrene (ABS) resin. In other words, the sloped guide not having a low-friction contact surface is formed of a different material from the sloped guide having a low-friction contact surface.

### <External Appearance of Main Case>

As illustrated in FIGS. 12 and 13, the main case 31 has the left outer surface 61 (an example of the third outer surface), the right outer surface 62 (an example of the first outer surface), a front outer surface 63 (an example of the second outer surface), the rear outer surface 64, the upper outer surface 65, and the lower outer surface 66.

The left outer surface 61 and the right outer surface 62 are parallel to the up-down direction, and constitute outermost surfaces of the main case 31 in the left-right direction. Specifically, the left outer surface 61 and the right outer surface 62 are orthogonal to the left-right direction. The left outer surface 61 and the right outer surface 62 are arranged between the upper outer surface 65 and the lower outer surface 66 in the up-down direction. The axis of the printing tape roll 11 is interposed between the left outer surface 61 and the right outer surface 62 in the left-right direction.

The front outer surface 63 and the rear outer surface 64 are parallel to the up-down direction, and constitute outermost surfaces of the main case 31 in the front-rear direction. Specifically, the front outer surface 63 and the rear outer surface 64 are orthogonal to the front-rear direction. The front outer surface 63 and the rear outer surface 64 are arranged between the upper outer surface 65 and the lower outer surface 66 in the up-down direction. The axis of the printing tape roll 11 is interposed between the front outer surface 63 and the rear outer surface 64 in the front-rear direction.

The upper outer surface 65 and the lower outer surface 66 cross the up-down direction, and constitute outermost surfaces in the up-down direction. Specifically, the upper outer surface 65 and the lower outer surface 66 are orthogonal to the up-down direction. The printing tape roll 11 is interposed between the upper outer surface 65 and the lower outer surface 66 in the up-down direction.

The upper outer surface 65 overlaps an entirety of the head opening 41 and an entirety of the printing tape roll 11 in the up-down direction. As illustrated in FIG. 12, the upper outer surface 65 is rectangular in shape. The upper outer surface 65 has a first side 65A, a second side 65B, a third side 65C, and a fourth side 65D.

The first side 65A constitutes a right edge of the upper outer surface 65. A first recess 43A is formed at the first side 65A. The second side 65B opposes the first side 65A and constitutes a left edge of the upper outer surface 65. The third side 65C is orthogonal to the first side 65A and the second side 65B, and constitutes a front edge of the upper outer surface 65. The fourth side 65D opposes the third side 65C and constitutes a rear edge of the upper outer surface 65.

As illustrated in FIG. 16, the lower outer surface 66 has the notch 34D that defines a part of the head opening 41. The lower outer surface 66 has a rectangular shape with a corner cut out. The lower outer surface 66 has a fifth side 66A, a sixth side 66B, a seventh side 66C, and an eighth side 66D.

The fifth side 66A constitutes a right edge of the lower outer surface 66. The second recess 43B is formed at the fifth side 66A. The sixth side 66B opposes the fifth side 66A and constitutes a left edge of the lower outer surface 66. The seventh side 66C is orthogonal to the fifth side 66A and the sixth side 66B, and constitutes a front edge of the lower outer surface 66. The notch 34D is formed at the seventh side 66C. The eighth side 66D opposes the seventh side 66C and constitutes a rear edge of the lower outer surface 66.

The notch 34D constitutes a lower end portion of the head opening 41. The notch 34D extends from the seventh side 66C toward the eighth side 66D, and extends from the sixth side 66B toward the fifth side 66A at a region of the lower outer surface 66 that is further inward relative to the seventh side 66C. In other words, the notch 34D extends from the front outer surface 63 toward the rear outer surface 64, and extends from the left outer surface 61 toward the right outer surface 62 at a region of the lower outer surface 66 that is further inward relative to the front outer surface 63.

The right outer surface 62 connects the first side 65A of the upper outer surface 65 and the fifth side 66A of the lower outer surface 66 to each other in the up-down direction. The left outer surface 61 connects the second side 65B of the upper outer surface 65 and the sixth side 66B of the lower outer surface 66 to each other in the up-down direction. The front outer surface 63 connects the third side 65C of the upper outer surface 65 and the seventh side 66C of the lower outer surface 66 to each other in the up-down direction. The rear outer surface 64 connects the fourth side 65D of the upper outer surface 65 and the eighth side 66D of the lower outer surface 66 to each other in the up-down direction.

As illustrated in FIG. 11, a wall of the second frame body 36A that constitutes the left outer surface 61 opposes a draw-off portion 11E of the printing tape 11A in the printing tape roll 11 (i.e., the tape exit 36C).

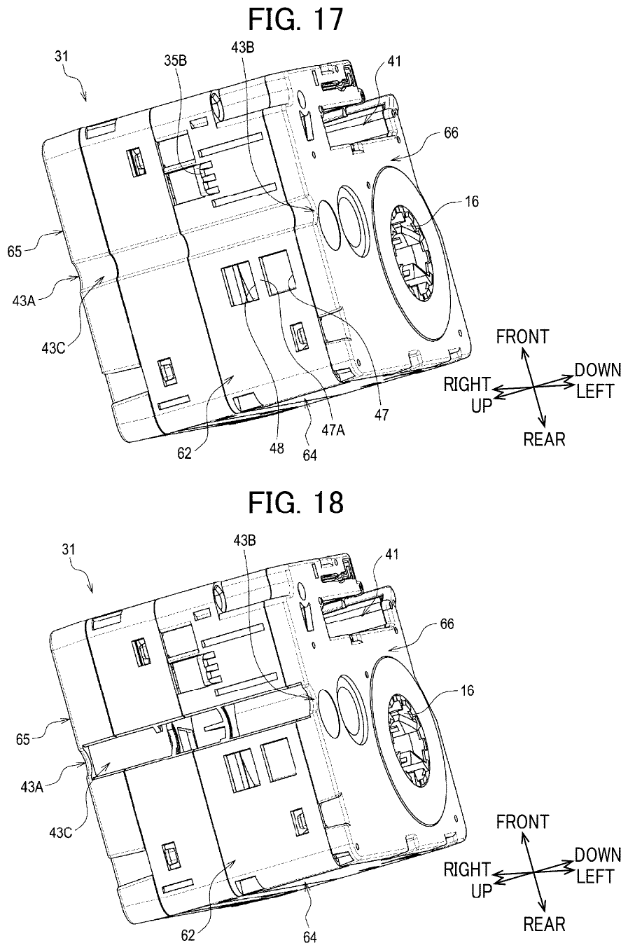

As illustrated in FIG. 17, the main case 31 has the first recess 43A, the second recess 43B, and the third recess 43C.

The first recess 43A is recessed leftward in a peripheral edge of the upper outer surface 65. The second recess 43B is recessed leftward in a peripheral edge of the lower outer surface 66. The third recess 43C extends from an upper end portion of the right outer surface 62 to a lower end portion of the right outer surface 62, and is recessed leftward. The first recess 43A, the second recess 43B, and the third recess 43C are arranged to be separated from the head opening 41.

At least a part of the first recess 43A overlaps at least a part of the second recess 43B in the up-down direction. Further, at least a part of the first recess 43A and at least a part of the second recess 43B overlap at least a part of the third recess 43C in the up-down direction. Specifically, an entirety of the first recess 43A overlaps an entirety of the second recess 43B and an entirety of the third recess 43C in the up-down direction.

The first recess 43A and the second recess 43B are defined by curved lines. As illustrated in FIG. 13, among three regions A1, A2, and A3 formed by dividing the upper outer surface 65 into three equal regions in the front-rear direction, the first recess 43A is included in a center region A2.

As illustrated in FIG. 17, the third recess 43C is a groove that extends in the up-down direction. A width and a depth of the third recess 43C is constant in the up-down direction. The third recess 43C is configured of a curved surface.

As illustrated in FIG. 9, in the thickness direction of the printing tape 11A, the third recess 43C overlaps a portion of the printing tape 11A that is further downstream in the conveying direction of the printing tape 11A relative to a portion of the printing tape 11A that contacts the first sloped guide 51 and the reflection wall 52. Further, in the thickness direction of the printing tape 11A, the third recess 43C overlaps a portion of the printing tape 11A that is further upstream in the conveying direction of the printing tape 11A relative to a portion of the printing tape 11A that overlaps the first engaging part 35B in the thickness direction of the printing tape 11A.

At least a part of the third recess 43C (specifically, a bottom part of the third recess 43C) is positioned further inward in the main case 31 in a direction orthogonal to the right outer surface 62 (i.e., the left-right direction) relative to an inner surface of a wall of the first frame body 35A that constitutes the right outer surface 62.

As illustrated in FIG. 11, the third recess 43C is defined by a wall of the second frame body 36A that is integrated with the roll frame wall 36B. As illustrated in FIGS. 2A and 2B, the protrusion 101A of the cassette accommodation part 101 is to be inserted into the second recess 43B and the third recess 43C in the up-down direction.

As illustrated in FIG. 17, the main case 31 has the reading window 47 (an example of the window) and a coupling opening 48. The reading window 47 and the coupling opening 48 are arranged in the up-down direction at the right outer surface 62.

The reading window 47 opposes the tape reading sensor 108 of the printing device body 100 in a state where the main case 31 is inserted in the cassette accommodation part 101. The reading window 47 overlaps, in the thickness direction of the printing tape 11A, a portion of the printing tape 11A that is further upstream in the conveying direction of the printing tape 11A relative to a portion of the printing tape 11A that overlaps the third recess 43C in the thickness direction of the printing tape 11A. That is, the reading window 47 is arranged in the right outer surface 62 at a position rearward of the third recess 43C.

The reading window 47 opposes both the reflection wall 52 and the first sloped guide 51 with the printing tape 11A interposed between the reading window 47, and the reflection wall 52 and the sloped guide 51. The reading window 47 allows light emitted by the tape reading sensor 108 and reflected inside the main case 31 to pass therethrough.

When coupling a plurality of printing cassettes 10 in the left-right direction, the second engaging part 35C of an adjacent printing cassette 10 is inserted into the coupling opening 48. The coupling opening 48 is positioned upward of the reading window 47. The reading window 47 and the coupling opening 48 are separated from each other by a rib 47A. By providing the rib 47A, strength of the main case 31 at the right outer surface 62 is improved.

As illustrated in FIG. 5, the main case 31 has the detection target part 45 arranged at the front outer surface 63 and indicating cassette identification information. The detection target part 45 enables the detection unit 106 of the printing device body 100 to detect the cassette identification information. The detection target part 45 has holes, recesses, or notches formed in the first frame part 35 (specifically, in the arm portion 44).

The detection unit 106 is configured to detect the cassette identification information through contact reading of a three-dimensional marker configured of the holes, the recesses, or the notches of the detection target part 45. The detection target part 45 has a first region for pressing the protrusions 106B of the detection unit 106, and a second region not pressing the protrusions 106B of the detection unit 106.

The first region is constituted by an outer wall of the main case 31 and is to press the protrusions 106B frontward. Holes are formed at the second region. In the second region, the protrusions 106B do not contact the detection target part 45 but pass through the holes and enters the inside of the main case 31.

The detection target part 45 is arranged at a position overlapping the head opening 41 in a direction orthogonal to the up-down direction (i.e., the radial direction of the printing tape roll 11). That is, the detection target part 45 is arranged at a different position from the printing tape roll 11 in the up-down direction.

As illustrated in FIG. 16, the detection target part 45 has a geometrical center of gravity G (see FIG. 5) that overlaps, in the thickness direction of the printing tape 11A, a portion of the printing tape 11A that is further upstream in the conveying direction of the printing tape 11A relative to a portion of the printing tape 11A that overlaps a rotational axis L2 of the second supply spool 15 (i.e., an axis of the ink ribbon roll 14) in the front-rear direction. The geometrical center of gravity G of the detection target part 45 is a center of gravity of a region in which the holes, the recesses, or the notches are formed.

Further, the geometrical center of gravity G of the detection target part 45 overlaps, in the thickness direction of the printing tape 11A, a portion of the printing tape 11A that is further upstream in the conveying direction of the printing tape 11A relative to a portion of the printing tape 11A that overlaps a right end portion of the heat sink 103 in the thickness direction of the printing tape 11A. Specifically, the geometrical center of gravity G of the detection target part 45 is positioned further rightward relative to the rotational axis L2 of the second supply spool 15 and the heat sink 103.

This configuration restrains positional deviation between the detection unit 106 and the detection target part 45 caused by the arm portion 44 deforming when the detection unit 106 contacts the detection target part 45. As a result, detection errors and operational malfunctions of the detection unit 106 is restrained.

As illustrated in FIG. 5, the main case 31 has a retracting recess 49 arranged at the front outer surface 63. The retracting recess 49 is configured to accommodate therein the auxiliary rib 106F of the detection unit 106. The retracting recess 49 is arranged between the geometrical center of gravity G of the detection target part 45 and the printing tape roll 11 in the up-down direction.

The main case 31 has the accommodation part 46 (an example of the accommodation recess) arranged at the left outer surface 61. The accommodation part 46 is a part recessed such that the accommodation part 46 can accommodate therein the cutter 110 of the printing device body 100. The accommodation part 46 is arranged rearward of the discharge opening 42. As illustrated in FIG. 2A, a part of the cutter 110 is arranged in the accommodation part 46.

As illustrated in FIG. 12, the main case 31 has an auxiliary recess 71 formed at a left-rear corner thereof. The auxiliary recess 71 is formed at the second cover body 37A. In cooperation with the first recess 43A, the second recess 43B, and the third recess 43C, the auxiliary recess 71 constitutes a grip part that can be gripped with fingers when removing the printing cassette 10 from the printing device body 100.

As illustrated in FIG. 5, the main case 31 has a plurality of reduced-thickness portions 72 extending in the up-down direction. The reduced-thickness portions 72 are slits formed at the left outer surface 61 and the front outer surface 63. The plurality of reduced-thickness portions 72 also constitute a grip part that can be gripped with fingers when removing the printing cassette 10 from the printing device body 100.

### <Molding of Main Case>

The first cover part 34, the first frame part 35, the second frame part 36, and the second cover part 37 are injection molded.

The first cover part 34 is molded with an inside (i.e., an upper side) in contact with the core of the mold and an outside (i.e., a lower side) in contact with the cavity of the mold. The second cover part 37 is molded with an inside (i.e., a lower side) in contact with the core of the mold and an outside (i.e., an upper side) in contact with the cavity of the mold.

The first frame part 35 is molded with a side at which the first sloped guide 51 is provided (i.e., a lower side) in contact with the core of the mold and a side opposite from the first sloped guide 51 (i.e., an upper side) in contact with the cavity of the mold.

The second frame part 36 is molded with a side at which the second sloped guide 53 is provided (i.e., an upper side) in contact with the core of the mold and a side opposite from the second sloped guide 53 (i.e., a lower side) in contact with the cavity of the mold.

Therefore, the sides that contacted the core of the mold are coupled together when coupling the first cover part 34 and the first frame part 35 to each other and when coupling the second frame part 36 and the second cover part 37 to each other. Further, the sides that contacted the cavity of the mold are coupled together when coupling the first frame part 35 and the second frame part 36 to each other.

Each of the first roller 17A and the second roller 17C are arranged at a region of the main case 31 that contacted the core of the mold. Accordingly, drafts of shaft parts for the first roller 17A and the second roller 17C are smaller, thereby increasing positioning accuracy of the first roller 17A and the second roller 17C.

<Conveyance and Printing of Tape with Printing Device Body>

In a state where the printing cassette 10 is attached to the printing device body 100, the print head 102 is arranged in the head opening 41 at a position overlapping the printing tape 11A and the ink ribbon 14A in the front-rear direction.

The printing tape 11A is conveyed to the head opening 41 by the platen roller 104 and is pressed against the print head 102, whose heating elements are heated, through the ink ribbon 14A by the platen roller 104. As a result, some of ink provided on a surface of the ink ribbon 14A is transferred onto the printing tape 11A, whereby characters, symbols, and the like is printed on the printing tape 11A.

The platen roller 104 conveys the printed printing tape 11A from an inside of the printing cassette 10 toward an outside of the printing cassette 10 through the discharge opening 42. The platen roller 104 rotates by the platen gear 105, which is in engagement with the output gear 21. The platen roller 104 is pivotally movable by the roller holder 107 between a position in which the platen roller 104 is separated from the printing cassette 10 and a position in which the platen gear 105 is in engagement with the output gear 21.

In a state where the main case 31 of the printing cassette 10 is inserted in the cassette accommodation part 101, the drive shaft 109 is in engagement with the input gear 22 and the platen gear 105 is in engagement with the output gear 21.

Specifically, by the platen roller 104 pivotally moving toward the head opening 41 of the printing cassette 10 in a state where the drive shaft 109 is inserted in the take-up spool 16 and the input gear 22 of the printing cassette 10, the platen gear 105 engages with the output gear 21.

As the drive shaft 109 rotates the input gear 22 when the printing cassette 10 is in an attached state, the output gear 21 is rotated via the idle gear 23. The rotation of the output gear 21 also rotates the platen gear 105, whereby the platen roller 104 rotates.

### <Modifications of First Embodiment>

As illustrated in FIG. 18, the third recess 43C may have a hole formed in the right outer surface 62. In FIG. 18, the entirety of the third recess 43C is configured of a hole.

### <1-2. Advantageous Effects>

The embodiment described above obtains the following advantageous effects.

(1a) A difference between the color of the reflection wall 52 and the color of the nontransparent parts 11D of the printing tape 11A enables the final end portion 11B of the printing tape 11A to be detected with a light entered from the outside of the printing cassette 10. Accordingly, there is no need to provide a space for arranging a sensor within the main case 31 of the printing cassette 10, thereby realizing downsizing of the printing cassette 10.

(1b) The first low-friction contact surface of the reflection wall 52 can reduce a frictional resistance between the printing tape 11A and the conveying path, thereby restraining defects from occurring when conveying the printing tape 11A.

### 2. Other Embodiments

While descriptions have been made with reference to the embodiments of the present disclosure, it should be apparent that the present disclosure can take various forms and is not limited to the above embodiments.

(2a) The printing device in the above embodiments is not limited to a device configured to perform printing using an ink ribbon. For example, the printing device may perform printing on a strip of heat-sensitive paper. That is, the printing cassette need not include an ink ribbon.

(2b) In the printing cassette of the above embodiments, the printing tape roll and the ink ribbon roll do not necessarily be wound over spools. In other words, the printing tape roll and the ink ribbon roll need not have a core.

(2c) In the printing cassette of the above embodiments, the reflection wall, the first sloped guide, and the second sloped guide may be provided at a conveying path for tape other than the printing tape (for example, the ink ribbon).

(2d) In the printing cassette of the above embodiments, the drive transmission mechanism may be arranged further upward relative to the printing tape roll or further downward relative to the conveying path for the printing tape. Further, the printing cassette need not include a drive transmission mechanism.

(2e) Functions possessed by a single component in the above embodiments may be distributed among a plurality of components, and functions possessed by a plurality of components may be integrated into a single component. Additionally, a part of the structures in the above embodiments may be omitted. Further, at least a part of the structures in the above embodiments may be added to or used in place of structures in other embodiments. All aspects included in the technical concepts identified from the recitations in the claims are embodiments of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing cassette comprising:
a printing tape roll including a printing tape, the printing tape being wound; and
a case accommodating therein the printing tape roll,
wherein the printing tape has a final end portion in which at least one transparent part and at least one nontransparent part are arranged juxtaposed in a longitudinal direction of the printing tape,
wherein the case has:
a conveying path along which the printing tape drawn out of the printing tape roll is to be conveyed toward a printing position; and
a reflection wall arranged at the conveying path, the reflection wall being configured to reflect light that has entered an inside of the case from an outside of the case and that has passed through the transparent part to allow the light to pass through the transparent part again and exit the case, and
wherein the reflection wall has a surface including a reflecting area configured to oppose the transparent part, the reflecting area having a color different from a color of the nontransparent part.

2. The printing cassette according to claim 1,
wherein, in the final end portion, the transparent part and the nontransparent part are arranged alternately in the longitudinal direction of the printing tape.

3. The printing cassette according to claim 1,
wherein the reflection wall contacts the printing tape.

4. The printing cassette according to claim 3,
wherein the reflection wall has a first low-friction contact surface having an uneven shape that contacts the printing tape.

5. The printing cassette according to claim 4,
wherein the first low-friction contact surface is configured of a coating material.

6. The printing cassette according to claim 5,
wherein the coating material is a surface layer of a film that is affixed to an inner surface of the conveying path.

7. The printing cassette according to claim 1,
wherein the color of the nontransparent part is black, and
wherein the color of the reflecting area is white.

8. The printing cassette according to claim 7,
wherein a color of a region upstream or downstream relative to the reflection wall in the conveying path is black.

9. The printing cassette according to claim 1,
wherein the printing position is a different position from the printing tape roll in a first direction parallel to an axis of the printing tape roll.

10. The printing cassette according to claim 9,
wherein the reflection wall overlaps the printing position in a direction orthogonal to the first direction.

11. The printing cassette according to claim 10,
wherein the case further has:
a case body having the conveying path, and
wherein the reflection wall is attachable to and detachable from the case body.

12. The printing cassette according to claim 11,
wherein the reflection wall is inserted in the case body in the first direction.

13. The printing cassette according to claim 11,
wherein the case further has:
a guide arranged at a position overlapping the printing position in the direction orthogonal to the first direction, the guide altering a conveying direction of the printing tape to another direction orthogonal to the first direction, and
wherein the reflection wall is arranged adjacent to the guide on a downstream side of the guide in the conveying direction of the printing tape.

14. The printing cassette according to claim 13,
wherein the conveying path has a region along which the printing tape is to be conveyed in the another direction orthogonal to the first direction, the reflection wall being arranged at the region of the conveying path.

15. The printing cassette according to claim 13,
wherein the reflection wall is attachable to and detachable from the case body together with the guide in a state where the reflection wall is integrated with the guide.

16. The printing cassette according to claim 13,
wherein the guide has a second low-friction contact surface having an uneven shape that contacts the printing tape.

17. The printing cassette according to claim 16,
wherein the second low-friction contact surface is configured of a coating material.

18. The printing cassette according to claim 17,
wherein the coating material is a surface layer of a film that is affixed to an inner surface of the conveying path.

19. The printing cassette according to claim 16,
wherein a material of the case body is acrylonitrile butadiene styrene resin, and
wherein a material of the guide is polyoxymethylene resin or polybutylene terephthalate resin.

20. The printing cassette according to claim 1,
wherein the case further has:
a first outer surface parallel to a first direction that is parallel to an axis of the printing tape roll; and
a window arranged on the first outer surface, the window opposing the reflection wall with the printing tape interposed between the window and the reflection wall.

21. The printing cassette according to claim 20,
wherein the window is configured to oppose a tape reading sensor of a printing device body, the case being to be inserted into the printing device body.

22. The printing cassette according to claim 20,
wherein the case further has:
a second outer surface parallel to the first direction and crossing the first outer surface; and
a detection target part arranged on the second outer surface, the detection target part enabling a printing device body to detect cassette identification information, the case being to be inserted into the printing device body.

23. The printing cassette according to claim 22,
wherein the detection target part is arranged at a position overlapping the printing position in a direction orthogonal to the first direction.

24. The printing cassette according to claim 22, further comprising:
an output gear for externally outputting a driving force, the output gear being arranged closer to the printing tape roll than the detection target part is to the printing tape roll in the first direction.

25. The printing cassette according to claim 20,
wherein the case further has:
a third outer surface, the third outer surface and the first outer surface constituting outermost surfaces of the case in a second direction orthogonal to the first direction, and
wherein a wall constituting the third outer surface opposes a draw-off portion of the printing tape in the printing tape roll.

26. The printing cassette according to claim 20,
wherein the case further has:
a third outer surface, the third outer surface and the first outer surface constituting outermost surfaces of the case in a second direction orthogonal to the first direction; and
an accommodation recess arranged on the third outer surface, the accommodation recess being configured to accommodate therein a cutter of a printing device body, the case being to be inserted into the printing device body.

27. The printing cassette according to claim 9, further comprising:
an ink ribbon roll including an ink ribbon, the ink ribbon being wound, the ink ribbon being to be used for printing on the printing tape,
wherein the ink ribbon roll is accommodated in the case, the ink ribbon roll being arranged at a position overlapping the printing position in a direction orthogonal to the first direction.

28. The printing cassette according to claim 27, further comprising:
an output gear for externally outputting a driving force, the output gear being arranged between the printing tape roll and the ink ribbon roll in the first direction,
wherein the output gear has angled teeth.

29. The printing cassette according to claim 1,
wherein the case further has:
an opening at the printing position, the opening allowing a print head of a printing device body to be inserted thereinto, the case being to be inserted into the printing device body.

30. A printing device comprising:
a cassette accommodation part into which a printing cassette is to be inserted, the printing cassette including a printing tape roll and a case, the printing tape roll including a printing tape, the printing tape being wound, the case accommodating therein the printing tape roll; and
a tape reading sensor configured to detect a final end of the printing tape,
wherein the printing tape has a final end portion in which at least one transparent part and at least one nontransparent part are arranged juxtaposed in a longitudinal direction of the printing tape,
wherein the case has:
a conveying path along which the printing tape drawn out of the printing tape roll is to be conveyed toward a printing position; and
a reflection wall arranged at the conveying path, the reflection wall being configured to reflect light that has entered an inside of the case from an outside of the case and that has passed through the transparent part to allow the light to pass through the transparent part again and exit the case, and
wherein the reflection wall has a surface including a reflecting area configured to oppose the transparent part, the reflecting area having a color different from a color of the nontransparent part.
